(19) United States
(12) Patent Application Publication
(10) Pub. No.: US 2005/0068622 A1
(43) Pub. Date: Mar. 31, 2005

(54) Polarizing beam splitting film and polarizing beam splitting prism

(75) Inventor: Takuji Hatano, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 10/952,965

(22) Filed: Sep. 29, 2004

(30) Foreign Application Priority Data
Sep. 30, 2003 (JP) 2003-342304

(51) Int. Cl. G03H 1/02; G02B 5/30; G02B 27/28

(52) U.S. Cl. 359/495; 359/501

(57) ABSTRACT

A polarizing beam splitting film and a polarizing beam splitting prism perform polarizing beam splitting on light in three different wavelength bands with high splitting performance and with low light absorption. The polarizing beam splitting film is built with three film groups that perform polarizing beam splitting on light in wavelength bands centered around 405 nm, 650 nm, and 780 nm. Of the thin films with which the polarizing beam splitting film is built, high-refractive-index ones are formed of titanium dioxide in the film groups for the 650 and 780 wavelength bands and of a mixture (H4) of titanium oxide and lanthanum oxide, which has a lower refractive index but absorbs less light than titanium oxide, in the film group for the 405 nm wavelength band. The polarizing beam splitting film is formed on or in a prism to produce a polarizing beam splitting prism.

This application is based on Japanese Patent Application No. 2003-342304 filed on Sep. 30, 2003, the contents of which are hereby incorporated by reference.

### BACKGROUND OF THE INVENTION

1. Field of the Invention

The present invention relates to a polarizing beam splitting film that transmits p-polarized light and reflects s-polarized light, and also relates to a polarizing beam splitting prism incorporating such a polarizing beam splitting film. More particularly, the present invention relates to a polarizing beam splitting film and a polarizing beam splitting prism that perform polarizing beam splitting on light in three different wavelength bands.

2. Description of Related Art

In an optical pickup used to input and output data to and from an optical recording medium such as a compact disc (CD) or digital versatile disc (DVD), splitting of an optical path is achieved by the use of a polarizing beam splitting prism incorporating a polarizing beam splitting (PBS) film. A polarizing beam splitting film is composed of a plurality of high- and low-refractive-index thin films laid on one another. The difference in refractive index between these thin films causes p-polarized light to be transmitted and s-polarized light to be reflected.

In general, in a polarizing beam splitting film, the greater the difference in refractive index between the high- and low-refractive-index thin films, the higher the performance with which p- and s-polarized light are split. For this reason, the thin films are typically formed of titanium dioxide (TiO₂), with a refractive index as high as 2.35, and silicon dioxide (SiO₂), with a refractive index as low as 1.452. The thin films may be formed of any material other than these, but in any case a polarizing beam splitting film is built by laying a number of high- and low-refractive-index thin films alternately on one another.

A polarizing beam splitting film exhibits wavelength dependence, meaning that, as the wavelength of the incident light varies, the transmissivity and reflectivity of the polarizing beam splitting film to p- and s-polarized light vary. A polarizing beam splitting film also exhibits angle-of-incidence dependence, meaning that, as the angle of incidence of the incident light varies, even if the wavelength of the light is constant, the wavelengths at which the polarizing beam splitting film exhibits a maximum transmissivity to p-polarized light and a maximum reflectivity to s-polarized light vary.

When a polarizing beam splitting film is actually used, the wavelength of the light emitted from a light source may vary from one light source to another, the target to perform polarizing beam splitting on may be divergent or convergent light, and there may be alignment errors in how the polarizing beam splitting film is arranged. To cope with such circumstances, a polarizing beam splitting film is built with a large number of thin films so that it offers its function of transmitting almost all p-polarized light and reflecting almost all s-polarized light over a certain wavelength band. This wavelength band has a width of about 20 nm (the design wavelength±10 nm), and this corresponds to a range of angles of incidence of 120 (the design angle of incidence±6°) at the design wavelength.

The wavelength of the light used for CDs is about 780 nm, and the wavelength of the light used for DVDs, which afford higher recording densities than CDs, is about 650 nm. A single optical pickup is often designed to be capable of handling input and output to and from both CDs and DVDs. This helps achieve miniaturization and cost reduction in devices that can handle both types of optical recording medium. Such an optical pickup employs a polarizing beam splitting film having two polarizing beam splitting films laid on each other, namely one for light in a wavelength range centered around 780 nm and another for light in a wavelength range centered around 650 nm (for example, as disclosed in U.S. Pat. No. 6,623,121).

In recent years, optical recording media with still higher densities have been under development, and the wavelength of the light used to achieve input and output to and from them is 405 nm. Even when these higher-density recording media are put into practical use in the future, they will not immediately supplant CDs and DVDs, which will therefore continue to be used. Accordingly, it is desirable to design a single optical pickup to be capable of handling input and output to and from all those types of optical recording medium in order to prevent the upsizing of devices that handle them. One may expect that this can be achieved by the use of a polarizing beam splitting film having three polarizing beam splitting films laid on one another, namely one for light in a wavelength range centered around 780 nm, another for light in a wavelength range centered around 650 nm, and a third for light in a wavelength range centered around 405 nm.

In reality, however, a so structured polarizing beam splitting film necessarily includes a large number of thin films, and thus absorbs accordingly much light. In optical pickups, which are supposed to be compact and lightweight, a semiconductor laser is commonly used as a light source. The problem here is that the light emission intensity of a semiconductor laser that emits light with a wavelength as short as 405 nm is considerably lower than that of a laser that emits light with a wavelength of 650 nm or 780 nm. Thus, the polarizing beam splitting film needs to be designed to absorb as little short-wavelength light as possible.

Titanium dioxide, on one hand, has the advantage of having a high reflective index, which makes it suitable as a material of high-refractive-index thin films, but, on the other, has the disadvantage of absorbing much light, in particular short-wavelength light. Accordingly, in a polarizing beam splitting film designed to work in three wavelength bands centered around 405 nm, 650 nm, and 780 nm, using titanium dioxide as the material of high-refractive-index thin films throughout the polarizing beam splitting film makes it difficult to yield light with wavelengths centered around 405 nm with sufficiently high intensity.

Light absorption can be reduced by using a low-light-absorption composite material called H4 as the material of high-refractive-index thin films. Here, the composite material H4 is a mixture of titanium dioxide and lanthanum oxide. The problem here is that such a material has a refractive index lower than that of titanium dioxide itself. Accordingly, using it as the material of high-refractive-index thin films throughout a polarizing beam splitting film lowers the performance with which it splits p- and s-polarized light in all the wavelength bands. The polarizing beam splitting film now exhibits marked dependence on angle of incidence, permitting satisfactory polarizing beam splitting only in narrower wavelength bands.

### SUMMARY OF THE INVENTION

In view of the conventionally encountered problems described above, it is an object of the present invention to provide a polarizing beam splitting film and a polarizing beam splitting prism that perform polarizing beam splitting on light in three different wavelength bands with high splitting performance and with low light absorption.

To achieve the above object, in one aspect of the invention, a polarizing beam splitting film for transmitting p-polarized light and reflecting s-polarized light is provided with at least three types of thin film having different refractive indices. This polarizing beam splitting film performs polarizing beam splitting on light in three different wavelength bands.

This polarizing beam splitting film performs polarizing beam splitting on light in three wavelength bands, and is built, not with two types of thin film as conventionally practiced, but with three or more types of thin film. This permits more flexibility in how to combine high- and low-refractive-index thin films. For example, it is possible to use one combination of thin films in the part of the polarizing beam splitting film that performs polarizing beam splitting on light of one wavelength band, and to use another combination of thin films in the other parts of the polarizing beam splitting film that perform polarizing beam splitting on light of the other two wavelength bands. This makes it possible to prevent the presence of high-light-absorption thin films throughout the polarizing beam splitting film, and thereby to reduce light absorption. Moreover, it is now easy to design the polarizing beam splitting film to offer satisfactory polarizing beam splitting performance for light of each of the three wavelength bands.

Here, preferably, the polarizing beam splitting film performs polarizing beam splitting on light in wavelength bands of which the center wavelengths are about 405 nm, about 650 nm, and about 780 nm, respectively. This polarizing beam splitting film performs polarizing beam splitting on the light used to achieve input and output of data to and from CDs, DVDs, and next-generation optical recording media, and contributes to reduced absorption of the light used to achieve input and output of data to and from next-generation optical recording media.

Preferably, the polarizing beam splitting film is built with two types of thin film having refractive indices of 2.0 or more and one type of thin film having a refractive index of 1.5 or less. This produces a difference of 0.5 or more between the refractive indices of the high- and low-refractive-index thin films, and thus makes it easy to obtain satisfactory polarizing beam splitting performance for light of each of the three wavelength bands.

Alternatively, the polarizing beam splitting film is built with two types of thin film having refractive indices of 2.0 or more and two types of thin film having refractive indices of 1.65 or less. This too makes it possible to obtain satisfactory polarizing beam splitting performance for light of each of the three wavelength bands.

Preferably, the material of the thin film having the highest refractive index is titanium dioxide, and the material of the thin film having the lowest refractive index is silicon dioxide. These materials not only have refractive indices suitable to achieve high splitting performance but also have excellent stress properties. Thus, they are suitable also to obtain sufficient mechanical strength in the polarizing beam splitting film, which tends to be thick so as to be capable of performing polarizing beam splitting on light in three wavelength bands.

To achieve the above object, in another aspect of the invention, a polarizing beam splitting prism has a polarizing beam splitting film as described above formed on a surface of a transparent substrate or at a bonding surface between transparent substrates.

### BRIEF DESCRIPTION OF THE DRAWINGS

FIG. 1 is a sectional view schematically showing the structure of the polarizing beam splitting film of a first embodiment of the invention;

FIGS. 2A to 2C are diagrams showing the transmissivity to p- and s-polarized light as observed in one design example of the polarizing beam splitting film of the first embodiment;

FIG. 3 is a sectional view schematically showing the structure of the polarizing beam splitting film of a second embodiment of the invention;

FIGS. 4A to 4C are diagrams showing the transmissivity to p- and s-polarized light as observed in one design example of the polarizing beam splitting film of the second embodiment;

FIG. 5 is a sectional view schematically showing the structure of the polarizing beam splitting film of a third embodiment of the invention;

FIGS. 6A to 6C are diagrams showing the transmissivity to p- and s-polarized light as observed in one design example of the polarizing beam splitting film of the third embodiment;

FIG. 7 is a sectional view schematically showing the structure of the prism of a fourth embodiment of the invention;

FIG. 8 is a diagram schematically showing the construction of an optical pickup adopting the prism of the fourth embodiment;

FIG. 9 is a sectional view schematically showing the structure of the prism of a fifth embodiment of the invention;

FIG. 10 is a diagram schematically showing the construction of an optical pickup adopting the prism of the fifth embodiment;

FIG. 11A to 11C are diagrams showing the transmissivity to p- and s-polarized light as observed in one design example of a polarizing beam splitting film as one comparative example in which the high-refractive-index films are formed solely of titanium dioxide; and

FIG. 12A to 12C are diagrams showing the transmissivity to p- and s-polarized light as observed in one design example of a polarizing beam splitting film as another comparative example in which the high-refractive-index films are formed solely of H4.

### DETAILED DESCRIPTION OF PREFERRED EMBODIMENTS

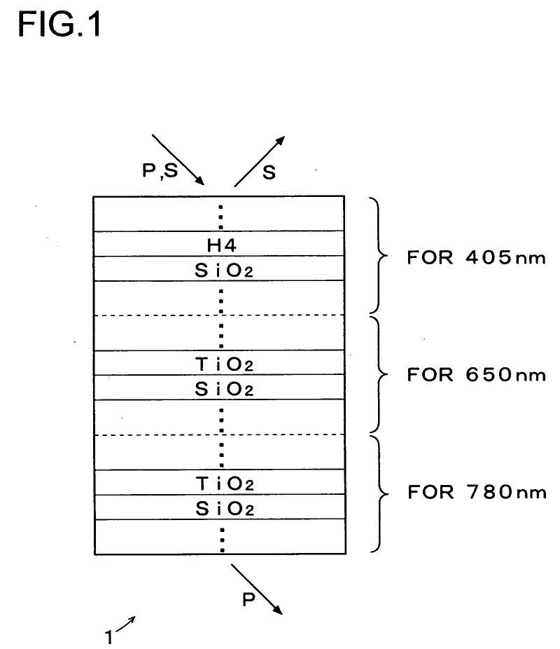

Hereinafter, polarizing beam splitting films and polarizing beam splitting prisms embodying the present invention will be described with reference to the drawings. The structure of the polarizing beam splitting film 1 of a first embodiment of the invention is schematically shown in FIG. 1. The polarizing beam splitting film 1 performs polarizing beam splitting on light in a first wavelength band of which the center wavelength is about 405 nm, light in a second wavelength band of which the center wavelength is about 650 nm, and light in a third wavelength band of which the center wavelength is about 780 nm. Accordingly, the polarizing beam splitting film 1 is composed of a film group that performs polarizing beam splitting on light in the first wavelength band, a film group that performs polarizing beam splitting on light in the second wavelength band, and a film group that performs polarizing beam splitting on light in the third wavelength band.

The film group that performs polarizing beam splitting on light in the first wavelength band is composed of thin films of H4-a mixture of titanium dioxide (TiO₂) and lanthanum oxide (La₂O₃) with a 60% or more lanthanum oxide content—and thin films of silicon dioxide (SiO₂) laid alternately on one another. The film group that performs polarizing beam splitting on light in the second wavelength band is composed of thin films of titanium dioxide and thin films of silicon dioxide laid alternately on one another. Likewise, the film group that performs polarizing beam splitting on light in the third wavelength band is composed of thin films of titanium dioxide and thin films of silicon dioxide laid alternately on one another. H4 has a refractive index of 2.09 at a wavelength of 550 nm; titanium dioxide has a refractive index of 2.35 at a wavelength of 600 nm; silicon dioxide has a refractive index of 1.452 at a wavelength of 600 nm.

In the polarizing beam splitting film 1, titanium dioxide is used as the high-refractive-index material, although it exhibits high light absorption. Its use, however, is limited to the film groups that perform polarizing beam splitting on light in the second and third wavelength bands. In the film group that performs polarizing beam splitting on light in the first wavelength band, H4, which exhibits lower light absorption, is used as the high-refractive-index material. This contributes to reduced absorption of the light, in particular that in the first, short-wavelength band, on which polarizing beam splitting is performed.

The polarizing beam splitting film 1 is designed to be formed inside a prism, i.e., at a bonding surface at which two optical materials are bonded together. The film group that performs polarizing beam splitting on light in the first wavelength band (around 405 nm) is contiguous with the optical material of the prism, and the film group that performs polarizing beam splitting on light in the third wavelength band (around 780 nm) is contiguous with the adhesive layer for bonding.

The polarizing beam splitting film 1 can be used, as shown in FIG. 1, in such a way as to receive the incident light at that side thereof where the film group that polarizing beam splitting on light in the first wavelength band is located or, in a reversed arrangement, in such a way as to receive the incident light at that side thereof where the film group that performs polarizing beam splitting on light in the third wavelength band is located. Of these two ways, the former is preferable because, in that way, s-polarized light in the first wavelength band is reflected before it reaches the thin films of the titanium dioxide, resulting in less absorption of the light.

A design example of the polarizing beam splitting film 1 is shown in Table 1. In the table, the individual thin films are serially numbered from the entrance side. Moreover, since there are three design wavelengths, the film thicknesses are expressed not as multiples of a design wavelength but as physical thicknesses (in nm). It should be noted that these rules apply to all the following tables. Here, it is assumed that the entrance-side medium (optical material) is SK10 (with a refractive index of 1.64), and that the exit-side medium (adhesive layer) has a refractive index of 1.52.

TABLE 1
Polarizing Beam Splitting Film 1 (TiO₂ + H4 + SiO₂)

| Layer | Mate- | Thickness | Layer | Mate- | Thickness |
|---|---|---|---|---|---|
| No. | rial | (nm) | No. | rial | (nm) |
| 1 | SiO₂ | 127.30 | 2 | H4 | 42.80 |
| 3 | SiO₂ | 82.83 | 4 | H4 | 33.93 |
| 5 | SiO₂ | 73.42 | 6 | H4 | 0 |
| 7 | SiO₂ | 54.57 | 8 | H4 | 42.58 |
| 9 | SiO₂ | 79.27 | 10 | H4 | 45.01 |
| 11 | SiO₂ | 87.69 | 12 | H4 | 44.92 |
| 13 | SiO₂ | 84.53 | 14 | H4 | 51.46 |
| 15 | SiO₂ | 85.64 | 16 | H4 | 27.29 |
| 17 | SiO₂ | 107.34 | 18 | H4 | 80.82 |
| 19 | SiO₂ | 121.85 | 20 | H4 | 84.51 |
| 21 | SiO₂ | 121.72 | 22 | H4 | 18.45 |
| 23 | SiO₂ | 140.90 | 24 | H4 | 67.90 |
| 25 | SiO₂ | 135.23 | 26 | TiO₂ | 62.18 |
| 27 | SiO₂ | 127.85 | 28 | TiO₂ | 60.26 |
| 29 | SiO₂ | 129.06 | 30 | TiO₂ | 72.94 |
| 31 | SiO₂ | 146.60 | 32 | TiO₂ | 84.15 |
| 33 | SiO₂ | 102.00 | 34 | TiO₂ | 73.30 |
| 35 | SiO₂ | 140.03 | 36 | TiO₂ | 80.63 |
| 37 | SiO₂ | 249.68 | 38 | TiO₂ | 110.90 |
| 39 | SiO₂ | 244.17 | 40 | TiO₂ | 110.57 |
| 41 | SiO₂ | 264.19 | 42 | TiO₂ | 102.57 |
| 43 | SiO₂ | 280.27 | 44 | TiO₂ | 44.52 |
| 45 | SiO₂ | 0 | 46 | TiO₂ | 50.40 |
| 47 | SiO₂ | 92.93 | | | |

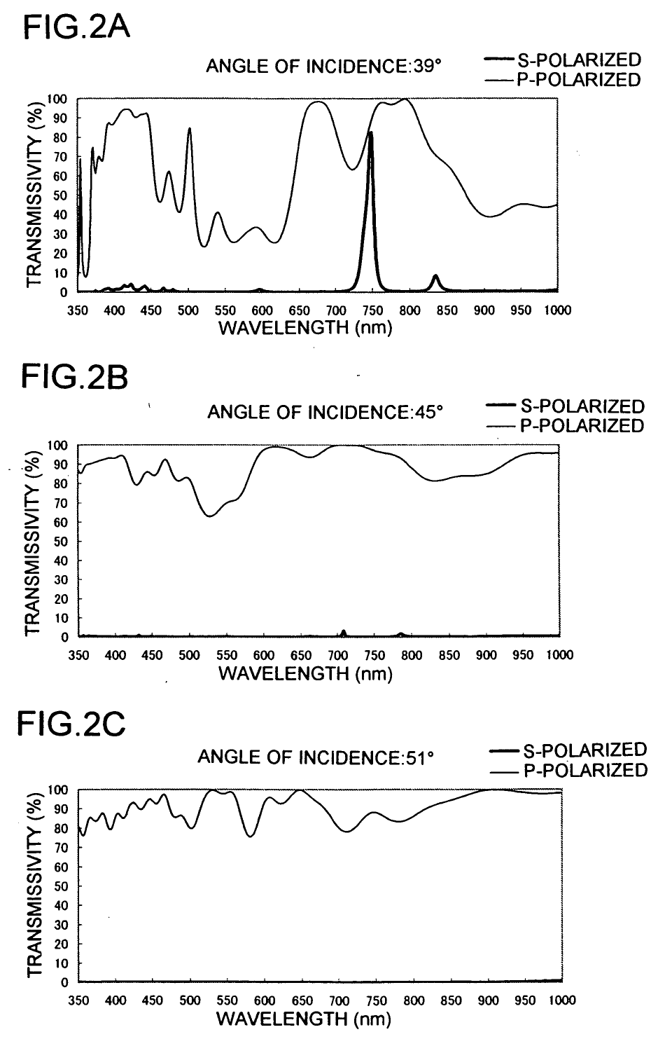

The transmissivity of the polarizing beam splitting film 1 in a range of wavelengths from 350 nm to 1,000 nm, as observed in the design example shown in Table 1, are shown in FIGS. 2A to 2C. In these diagrams, thick lines indicate the transmissivity to s-polarized light, and thin lines indicate the transmissivity to p-polarized light. FIGS. 2A, 2B, and 2C show the transmissivity observed at angles of incidence of 39°, 45°, and 51°, respectively. It should be noted that these rules apply to all the following transmissivity diagrams.

From FIGS. 2A to 2C, it is understood that almost all s-polarized light is reflected and 85% or more of p-polarized light is transmitted within the range of angles of incidence of 45° (the design value)±6°, in the wavelength bands of 405 nm±10 nm, 650 nm±15 nm, and 780 nm±20 nm. Thus, the polarizing beam splitting film 1 affords high splitting performance.

As a first comparative example, a design example of the polarizing beam splitting film in which the high-refractive-index thin films are formed solely of titanium dioxide is shown in Table 2. Here, as in the design example shown in Table 1, it is assumed that the entrance-side medium (optical material) is SK10, and that the exit-side medium (adhesive layer) has a refractive index of 1.52.

TABLE 2
Comparative Example 1 (TiO₂ + SiO₂)

| Layer | Mate- | Thickness | Layer | Mate- | Thickness |
|---|---|---|---|---|---|
| No. | rial | (nm) | No. | rial | (nm) |
| 1 | SiO₂ | 152.21 | 2 | TiO₂ | 32.51 |
| 3 | SiO₂ | 56.93 | 4 | TiO₂ | 42.91 |
| 5 | SiO₂ | 67.93 | 6 | TiO₂ | 43.15 |
| 7 | SiO₂ | 77.99 | 8 | TiO₂ | 37.87 |
| 9 | SiO₂ | 73.48 | 10 | TiO₂ | 42.87 |
| 11 | SiO₂ | 78.40 | 12 | TiO₂ | 41.31 |
| 13 | SiO₂ | 69.22 | 14 | TiO₂ | 43.51 |
| 15 | SiO₂ | 80.88 | 16 | TiO₂ | 32.32 |
| 17 | SiO₂ | 60.01 | 18 | TiO₂ | 48.13 |
| 19 | SiO₂ | 144.36 | 20 | TiO₂ | 74.58 |
| 21 | SiO₂ | 143.83 | 22 | TiO₂ | 58.80 |
| 23 | SiO₂ | 154.42 | 24 | TiO₂ | 79.18 |
| 25 | SiO₂ | 85.03 | 26 | TiO₂ | 75.83 |
| 27 | SiO₂ | 132.84 | 28 | TiO₂ | 74.71 |
| 29 | SiO₂ | 156.36 | 30 | TiO₂ | 64.86 |
| 31 | SiO₂ | 134.97 | 32 | TiO₂ | 6.39 |
| 33 | SiO₂ | 42.47 | 34 | TiO₂ | 52.57 |
| 35 | SiO₂ | 83.93 | 36 | TiO₂ | 106.83 |
| 37 | SiO₂ | 287.97 | 38 | TiO₂ | 111.40 |
| 39 | SiO₂ | 224.35 | 40 | TiO₂ | 100.13 |
| 41 | SiO₂ | 235.24 | 42 | TiO₂ | 133.38 |
| 43 | SiO₂ | 236.51 | 44 | TiO₂ | 120.85 |
| 45 | SiO₂ | 299.57 | 46 | TiO₂ | 27.41 |
| 47 | SiO₂ | 50.54 | 48 | TiO₂ | 31.37 |
| 49 | SiO₂ | 71.16 | | | |

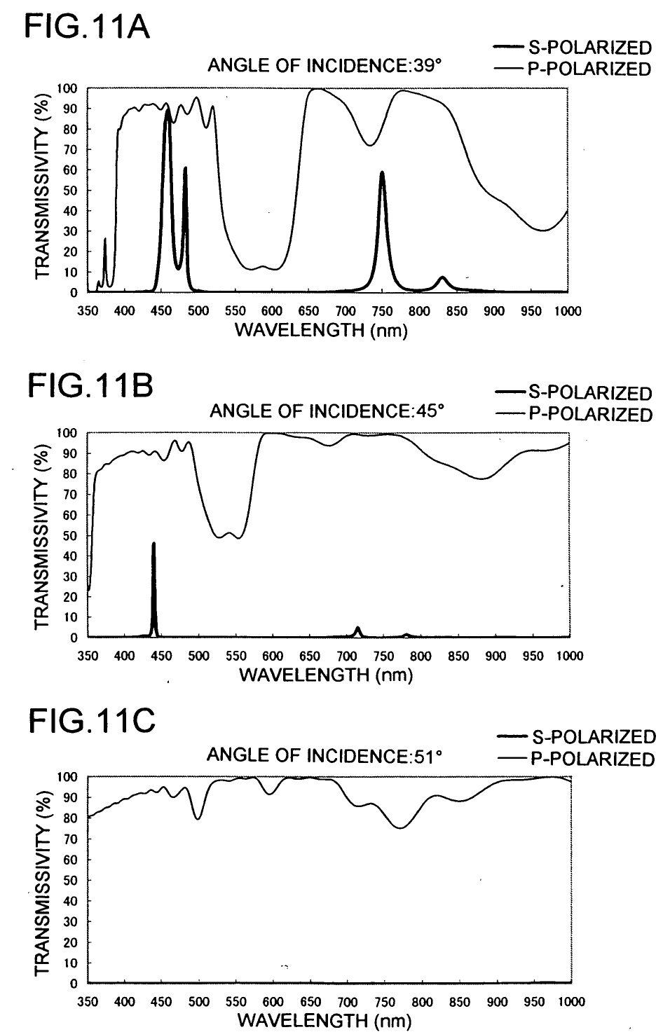

The transmissivity of the polarizing beam splitting film of the first comparative example, as observed when designed as shown in Table 2, are shown in FIGS. 11A to 11C. Comparison of FIGS. 2A to 2C with FIGS. 11A to 11C makes clear that the polarizing beam splitting film of the first embodiment affords, for light of all of the first, second, and third wavelength bands, polarizing beam splitting performance comparable with that offered by the structure in which the high-refractive-index thin films are formed solely of titanium dioxide.

As a second comparative example, a design example of the polarizing beam splitting film in which the high-refractive-index thin films are formed solely of H4 is shown in Table 3. Here, as in the design example shown in Table 1, it is assumed that the entrance-side meduim (optical material) is SK10, and that the exit-side medium (adhesive layer) has a refractive index of 1.52.

TABLE 3
Comparative Example 2 (H4 + SiO₂)

| Layer | Mate- | Thickness | Layer | Mate- | Thickness |
|---|---|---|---|---|---|
| No. | rial | (nm) | No. | rial | (nm) |
| 1 | SiO₂ | 1.41 | 2 | H4 | 37.68 |
| 3 | SiO₂ | 63.76 | 4 | H4 | 58.81 |
| 5 | SiO₂ | 55.58 | 6 | H4 | 0 |
| 7 | SiO₂ | 36.72 | 8 | H4 | 42.58 |
| 9 | SiO₂ | 85.89 | 10 | H4 | 54.19 |
| 11 | SiO₂ | 76.74 | 12 | H4 | 50.74 |
| 13 | SiO₂ | 90.50 | 14 | H4 | 50.59 |
| 15 | SiO₂ | 74.36 | 16 | H4 | 55.46 |
| 17 | SiO₂ | 104.31 | 18 | H4 | 62.24 |
| 19 | SiO₂ | 143.45 | 20 | H4 | 94.36 |
| 21 | SiO₂ | 96.11 | 22 | H4 | 8.56 |
| 23 | SiO₂ | 133.68 | 24 | H4 | 76.89 |
| 25 | SiO₂ | 120.53 | 26 | H4 | 71.80 |
| 27 | SiO₂ | 138.80 | 28 | H4 | 81.12 |
| 29 | SiO₂ | 144.35 | 30 | H4 | 80.20 |
| 31 | SiO₂ | 157.35 | 32 | H4 | 88.16 |
| 33 | SiO₂ | 149.83 | 34 | H4 | 92.53 |
| 35 | SiO₂ | 166.96 | 36 | H4 | 86.18 |
| 37 | SiO₂ | 227.26 | 38 | H4 | 133.19 |
| 39 | SiO₂ | 212.77 | 40 | H4 | 120.25 |
| 41 | SiO₂ | 252.26 | 42 | H4 | 135.56 |
| 43 | SiO₂ | 262.15 | 44 | H4 | 56.39 |
| 45 | SiO₂ | 0 | 46 | H4 | 63.36 |
| 47 | SiO₂ | 37.17 | | | |

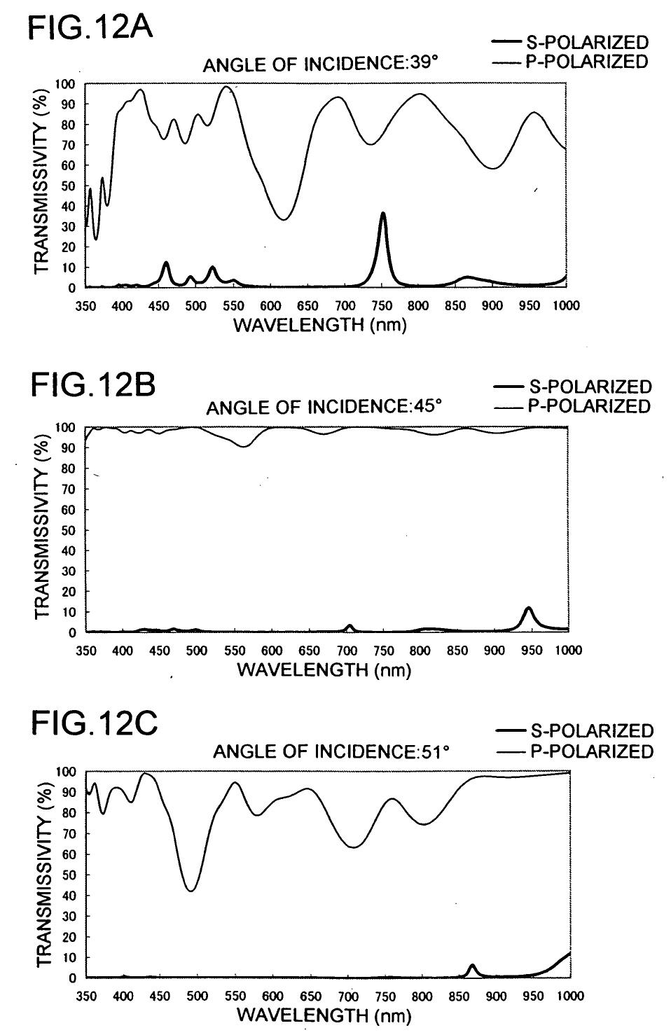

The transmissivity of the polarizing beam splitting film of the second comparative example, as observed when designed as shown in Table 3, are shown in FIGS. 12A to 12C. As is understood from FIG. 12B, when the angle of incidence is as designed, this polarizing beam splitting film affords, for light of all of the first, second, and third wavelength bands, satisfactory polarizing beam splitting performance that is comparable with or better than that offered by the polarizing beam splitting film 1 of the first embodiment or the polarizing beam splitting film of the first comparative example. However, as is clear from FIG. 12A, at an angle of incidence of 39° (6° smaller than the design value), it exhibits considerably low transmissivity to p-polarized light in the first wavelength band (around 405 nm) and in the second wavelength band (around 650 nm). Moreover, as is clear from FIG. 12C, also at an angle of incidence of 51° (6° greater than the design value), it exhibits low transmissivity to p-polarzied light in the second wavelength band.

As discussed above, using as the material of high-refractive-index thin films solely H4, which has a refractive index lower than that of titanium dioxide, with a view to reducing light absorption results in lower polarizing beam splitting performance at angles of incidence other than the design value. By contrast, with the polarizing beam splitting film 1 of the first embodiment, in which the high-refractive-index thin films are formed partly of titanium dioxide and partly of H4, it is possible to obtain high polarizing beam splitting performance even at angles of incidence slightly deviated from the design value.

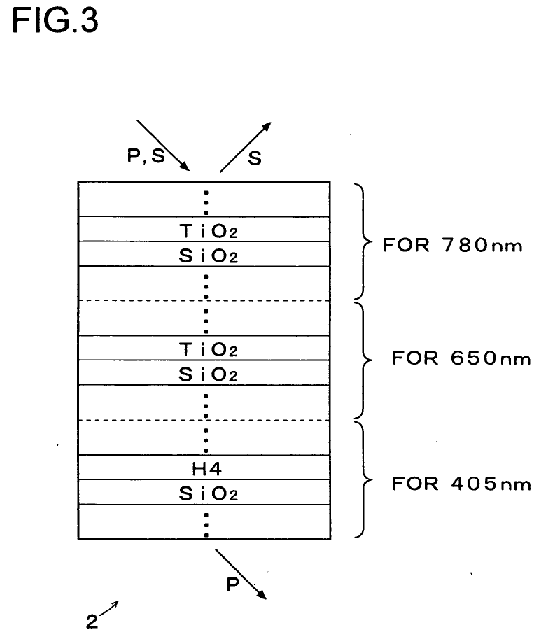

The structure of the polarizing beam splitting film 2 of a second embodiment of the invention is schematically shown in FIG. 3. The polarizing beam splitting film 2 is a modified version of the polarizing beam splitting film 1 of the first embodiment, the modification being the interchanging with each other of the film group that performs polarizing beam splitting on light in the first wavelength band, of which the center wavelength is about 405 nm, and the film group that performs polarizing beam splitting on light in the third wavelength band, of which the center wavelength is about 780 nm. The film group that performs polarizing beam splitting on light in the third wavelength band is contiguous with the optical material of the prism, and the film group that performs polarizing beam splitting on light in the first wavelength band is contiguous with the adhesive layer for bonding.

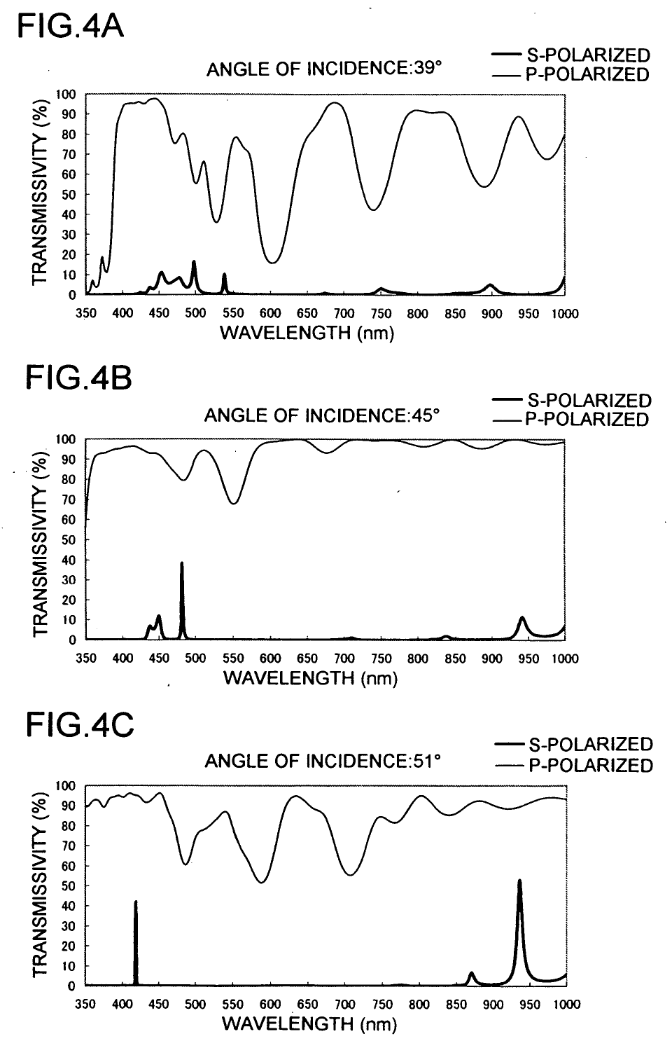

A design example of the polarizing beam splitting film 2 is shown in Table 4, and the transmissivity observed in this design example is shown in FIGS. 4A to 4C. Also here, it is assumed that the entrance-side medium (optical material) is SK10, and that the exit-side medium (adhesive layer) has a refractive index of 1.52.

TABLE 4
Polarizing Beam Splitting Film 2 (TiO₂ + H4 + SiO₂)

| Layer | Mate- | Thickness | Layer | Mate- | Thickness |
|---|---|---|---|---|---|
| No. | rial | (nm) | No. | rial | (nm) |
| 1 | SiO₂ | 146.82 | 2 | TiO₂ | 52.58 |
| 3 | SiO₂ | 32.49 | 4 | TiO₂ | 38.83 |
| 5 | SiO₂ | 76.00 | 6 | TiO₂ | 39.65 |
| 7 | SiO₂ | 93.74 | 8 | TiO₂ | 35.51 |
| 9 | SiO₂ | 59.66 | 10 | TiO₂ | 44.90 |
| 11 | SiO₂ | 93.29 | 12 | TiO₂ | 36.78 |
| 13 | SiO₂ | 72.66 | 14 | TiO₂ | 39.57 |
| 15 | SiO₂ | 75.14 | 16 | TiO₂ | 43.45 |
| 17 | SiO₂ | 59.91 | 18 | TiO₂ | 28.31 |
| 19 | SiO₂ | 131.79 | 20 | TiO₂ | 74.32 |
| 21 | SiO₂ | 139.72 | 22 | TiO₂ | 69.38 |
| 23 | SiO₂ | 87.41 | 24 | TiO₂ | 74.69 |
| 25 | SiO₂ | 116.49 | 26 | H4 | 92.93 |
| 27 | SiO₂ | 161.48 | 28 | H4 | 104.34 |
| 29 | SiO₂ | 162.01 | 30 | H4 | 75.86 |
| 31 | SiO₂ | 194.82 | 32 | H4 | 76.64 |
| 33 | SiO₂ | 184.06 | 34 | H4 | 90.15 |
| 35 | SiO₂ | 315.71 | 36 | H4 | 98.07 |
| 37 | SiO₂ | 166.03 | 38 | H4 | 90.35 |
| 39 | TiO₂ | 0 | 40 | SiO₂ | 223.58 |
| 41 | H4 | 142.55 | 42 | SiO₂ | 277.82 |
| 43 | H4 | 136.86 | 44 | SiO₂ | 268.55 |
| 45 | H4 | 122.48 | 46 | SiO₂ | 88.14 |

Comparison among FIGS. 4A to 4C, 2A to 2C, and 11A to 11C makes clear that, like the polarizing beam splitting film 1, the polarizing beam splitting film 2 affords, for light of all of the first, second, and third wavelength bands, polarizing beam splitting performance comparable with that offered by the polarizing beam splitting film of the first comparative example, in which the high-refractive-index thin films are formed solely of titanium dioxide. Moreover, the polarizing beam splitting film 2 exhibits less lowering of polarizing beam splitting performance even at angles of incidence deviated from the design value.

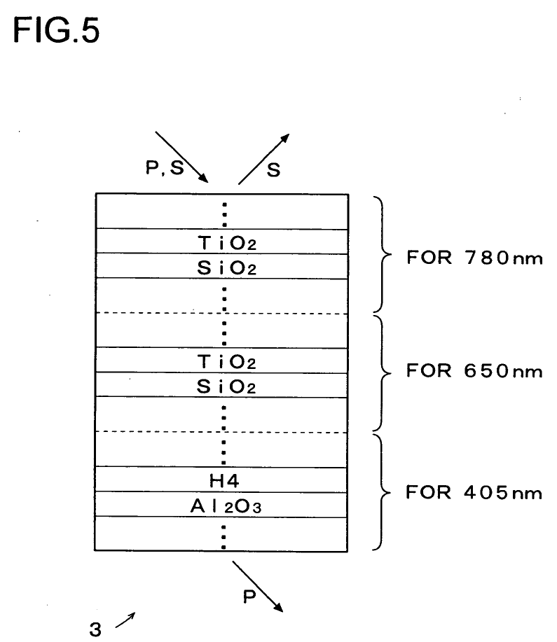

The structure of the polarizing beam splitting film 3 of a third embodiment of the invention is schematically shown in FIG. 5. The polarizing beam splitting film 5 also performs polarizing beam splitting on light in a first wavelength band of which the center wavelength is about 405 nm, light in a second wavelength band of which the center wavelength is about 650 nm, and light in a third wavelength band of which the center wavelength is about 780 nm. Accordingly, the polarizing beam splitting film 3 is composed of three film groups, namely those that perform polarizing beam splitting on light in the first, second, and third wavelength bands, respectively.

The film group that performs polarizing beam splitting on light in the first wavelength band is composed of thin films of H4 and thin films of aluminum oxide (Al₂O₃) laid alternately on one another. The film group that performs polarizing beam splitting on light in the second wavelength band is composed of thin films of titanium dioxide and thin films of silicon dioxide laid alternately on one another. Likewise, the film group that performs polarizing beam splitting on light in the third wavelength band is composed of thin films of titanium dioxide and thin films of silicon dioxide laid alternately on one another. Aluminum oxide has a refractive index of 1.62 at a wavelength of 550 nm.

The polarizing beam splitting film 3 is designed to be formed on a surface of a prism. The film group that performs polarizing beam splitting on light in the first wavelength band (around 405 nm) is contiguous with the optical material of the prism, and the film group that performs polarizing beam splitting on light in the third wavelength band (around 780 nm) is contiguous with air.

A design example of the polarizing beam splitting film 3 is shown in Table 5. Here, it is assumed that the exit-side medium (optical material) is LAF71. LAF 71 has a refractive index of 1.799 at a wavelength of 405 nm.

TABLE 5
Polarizing Beam Splitting Film 3 (TiO₂ + H4 + SiO₂ + Al₂O₃)

| Layer | Mate- | Thickness | Layer | Mate- | Thickness |
|---|---|---|---|---|---|
| No. | rial | (nm) | No. | rial | (nm) |
| 1 | TiO₂ | 72.82 | 2 | SiO₂ | 134.82 |
| 3 | TiO₂ | 45.25 | 4 | SiO₂ | 0 |
| 5 | TiO₂ | 227.19 | 6 | SiO₂ | 0 |
| 7 | TiO₂ | 83.94 | 8 | SiO₂ | 0 |
| 9 | TiO₂ | 182.30 | 10 | SiO₂ | 0 |
| 11 | TiO₂ | 0 | 12 | SiO₂ | 103.84 |
| 13 | TiO₂ | 0 | 14 | SiO₂ | 93.77 |
| 15 | TiO₂ | 89.05 | 16 | SiO₂ | 0 |
| 17 | TiO₂ | 0 | 18 | SiO₂ | 177.02 |
| 19 | TiO₂ | 67.97 | 20 | SiO₂ | 107.18 |
| 21 | TiO₂ | 59.41 | 22 | SiO₂ | 58.61 |
| 23 | TiO₂ | 0 | 24 | SiO₂ | 111.72 |
| 25 | TiO₂ | 53.53 | 26 | SiO₂ | 98.27 |
| 27 | TiO₂ | 50.22 | 28 | SiO₂ | 93.90 |
| 29 | TiO₂ | 52.39 | 30 | SiO₂ | 103.98 |
| 31 | TiO₂ | 57.17 | 32 | SiO₂ | 202.60 |
| 33 | TiO₂ | 57.40 | 34 | SiO₂ | 100.30 |
| 35 | TiO₂ | 110.70 | 36 | SiO₂ | 77.02 |
| 37 | TiO₂ | 23.45 | 38 | SiO₂ | 52.31 |
| 39 | TiO₂ | 37.11 | 40 | SiO₂ | 208.59 |
| 41 | TiO₂ | 40.75 | 42 | SiO₂ | 195.73 |
| 43 | TiO₂ | 38.82 | 44 | SiO₂ | 78.10 |
| 45 | TiO₂ | 44.25 | 46 | SiO₂ | 96.75 |
| 47 | TiO₂ | 73.08 | 48 | SiO₂ | 105.95 |
| 49 | TiO₂ | 62.42 | 50 | SiO₂ | 150.39 |
| 51 | H4 | 66.07 | 52 | Al₂O₃ | 162.95 |
| 53 | H4 | 74.21 | 54 | Al₂O₃ | 75.71 |
| 55 | H4 | 159.31 | 56 | Al₂O₃ | 78.00 |
| 57 | H4 | 133.09 | 58 | Al₂O₃ | 96.23 |
| 59 | H4 | 110.84 | 60 | Al₂O₃ | 103.23 |
| 61 | H4 | 105.99 | 62 | Al₂O₃ | 114.32 |
| 63 | H4 | 130.29 | 64 | Al₂O₃ | 31.62 |
| 65 | H4 | 64.08 | 66 | Al₂O₃ | 169.85 |
| 67 | H4 | 70.20 | 68 | Al₂O₃ | 92.05 |
| 69 | H4 | 125.70 | 70 | Al₂O₃ | 156.33 |
| 71 | H4 | 103.49 | 72 | Al₂O₃ | 178.74 |
| 73 | H4 | 94.85 | 74 | Al₂O₃ | 0 |
| 75 | H4 | 122.07 | 76 | Al₂O₃ | 146.09 |
| 77 | H4 | 0 | 78 | Al₂O₃ | 208.79 |
| 79 | H4 | 44.59 | 80 | Al₂O₃ | 225.78 |

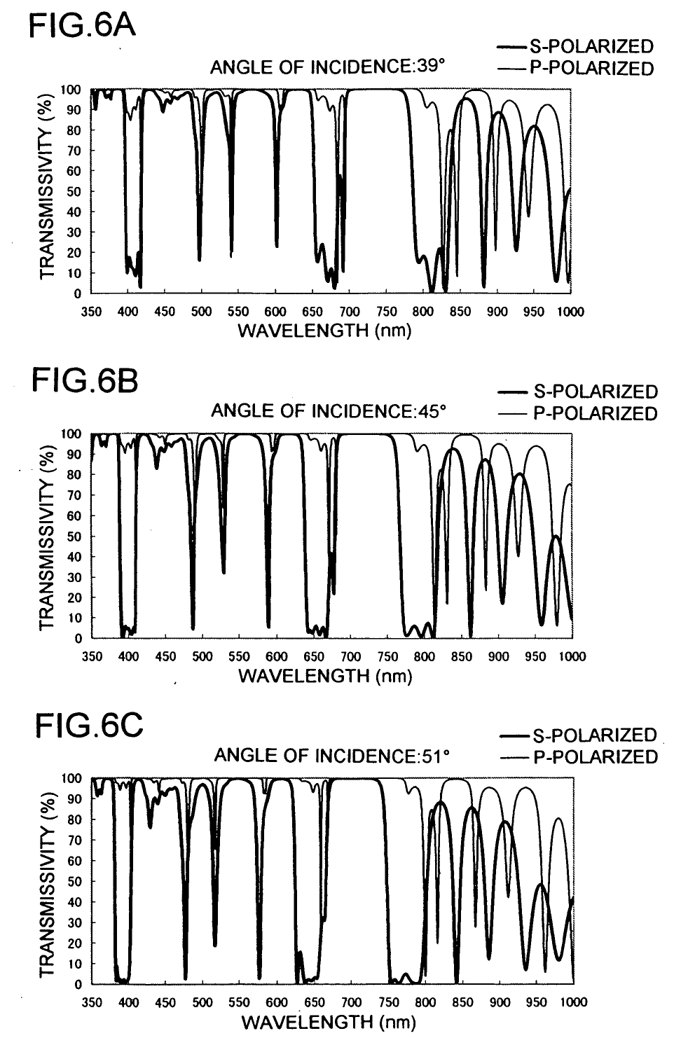

The transmissivity of the polarizing beam splitting film 3, as observed in the design example shown in Table 5, are shown in FIGS. 6A to 6C. As compared with the polarizing beam splitting films 1 and 2 of the first and second embodiments, the polarizing beam splitting film 3 transmits s-polarized light in more wavelength bands and reflects p-polarized light in more wavelength bands. Even then, the polarizing beam splitting film 3 split s- and p-polarized light satisfactorily within the range of angles of incidence of 45° (the design value)±6°, in the wavelength bands of 405 nm±10 nm, 650 nm±15 nm, and 780 nm±20 nm.

Now, embodiments of prisms incorporating one of the polarizing beam splitting films 1 to 3 of the first to third embodiments and optical pickups adopting such a prism will be described.

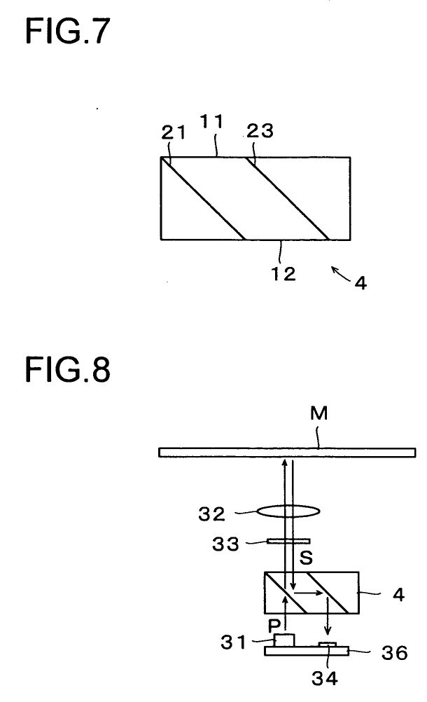

The structure of the prism 4 of a fourth embodiment of the invention is schematically shown in FIG. 7. The prism 4 is composed of the following three prism pieces bonded together: a prism piece having a trapezoidal cross section, a prism piece having a parallelogrammatic cross section, and a prism piece having a triangular cross section. The prism 4 overall has a rectangular cross section. At the two bonding surfaces are formed a polarizing beam splitting film 21 and a reflective film 23, respectively. The polarizing beam splitting film 21 and the reflective film 23 are parallel to each other, and are both at 45° to the surfaces 11 and 12 of the prism 4. Used as the polarizing beam splitting film 21 is the polarizing beam splitting film 1 of the first embodiment or the polarizing beam splitting film 2 of the second embodiment.

The construction of an optical pickup adopting the prism 4 is schematically shown in FIG. 8. This optical pickup includes, in addition to the prism 4, a laser light source 31, an objective lens 32, a quarter-wave phase plate 33, and a photodiode 34.

The laser light source 31 is composed of a laser diode that emits laser light of which the center wavelength is 405 nm, a laser diode that emits laser light of which the center wavelength is 650 nm, and a laser diode that emits laser light of which the center wavelength is 780 nm. These three laser diodes are arranged close to one another and in such a way that the principal rays emitted therefrom are parallel to one another. The light emission from the three laser diodes is controlled according to the type of optical recording medium M used so that only one of them which corresponds to the optical recording medium M emits laser light.

The laser light source 31 is arranged to face the surface 12 of the prism 4, with the principal ray of the laser light emitted therefrom at 45° to the polarizing beam splitting film 21. The orientation of the laser light source 31 is such that the laser light emitted therefrom is p-polarized with respect to the polarizing beam splitting film 21.

The objective lens 32 is arranged to face the surface 11, with the optical axis of the objective lens 32 aligned with the principal ray of the laser light emitted from the laser diode disposed at the center of the laser light source 31. The objective lens 32 makes the laser light emitted from the laser light source 31 and then transmitted through the polarizing beam splitting film 21 converge on the recording layer of the optical recording medium M. The quarter-wave phase plate 33 is arranged between the surface 11 of the prism 4 and the objective lens 32, with the quarter-wave phase plate 33 perpendicular to the optical axis of the objective lens 32.

The photodiode 34 is mounted on a circuit board 36, along with the laser light source 31 and beside it. The photodiode 34 is arranged parallel to the surface 12 so as to face the reflective film 23. Incidentally, the photodiode 34 has a plurality of regions that independently sense light, and permits the information recorded on the optical recording medium M to be detected according to the differences among the amounts of light received by those regions.

The light emitted from the laser light source 31 is transmitted through the surface 12 to strike the polarizing beam splitting film 21. Since the light here is linear-polarized and p-polarized with respect to the polarizing beam splitting film 21, it is all transmitted therethrough. After being transmitted through the polarizing beam splitting film 21, the light is transmitted through the surface 11, and is then transmitted through the quarter-wave phase plate 33, by which the light is converted into circular-polarized light. This light is then transmitted through the objective lens 32 so as to converge on the recording layer of the optical recording medium M, and is then reflected therefrom.

The light reflected by the optical recording medium M is transmitted through the objective lens 32, and is then transmitted through the quarter-wave phase plate 33, by which the light is converted back into linear-polarized light. Since the linear-polarized light here is s-polarized with respect to the polarizing beam splitting film 21, it is transmitted through the surface 11, and is then reflected from the polarizing beam splitting film 21. The light reflected by the polarizing beam splitting film 21 strikes the reflective film 23 so as to be reflected once again. The light is then transmitted through the surface 12, and reaches the photodiode 34.

The output signal of the photodiode 34 is fed to an unillustrated signal processing circuit. On the basis of the output signal of the photodiode 34, the signal processing circuit detects the information carried on the light from the optical recording medium M, i.e., the information recorded on the optical recording medium M.

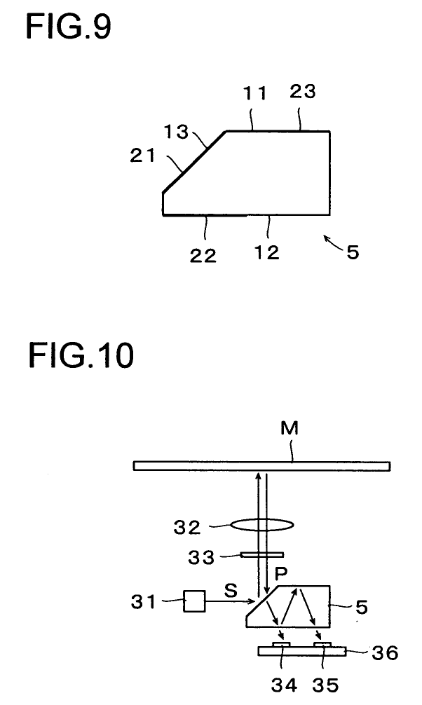

The structure of the prism 5 of a fifth embodiment of the invention is schematically shown in FIG. 9. The prism 5 has mutually parallel surfaces 11 and 12 and a surface 13 that is at 45° thereto. On the surface 13 is formed a polarizing beam splitting film 21, and on the surface 11 is formed a reflective film 23. Moreover, a semitransparent film 22 is formed on part of the surface 12, more specifically on the part thereof opposite to the surface 13 and on a part contiguous with that part and opposite to part of the surface 11. Used as the polarizing beam splitting film 21 is the polarizing beam splitting film 3 of the third embodiment.

The construction of an optical pickup adopting the prism 5 is schematically shown in FIG. 10. This optical pickup includes, in addition to the prism 5, a laser light source 31, an objective lens 32, and a quarter-wave phase plate 33 like those mentioned earlier, plus two photodiodes 34 and 35.

The laser light source 31 is so arranged that the principal ray of the laser light emitted therefrom is at 45° to the surface 13 of the prism 5. The orientation of the laser light source 31 is such that the laser light emitted therefrom is s-polarized with respect to the surface 13. The objective lens 32 is so arranged that the optical axis thereof meets the point at which the principal ray of the laser light emitted from the laser diode arranged at the center of the laser light source 31 intersects the surface 13, with the optical axis of the objective lens 32 at 45° to the surface 13. The objective lens 32 makes the laser light emitted from the laser light source 31 and then reflected from the surface 13 converge on the recording layer of the optical recording medium M.

The quarter-wave phase plate 33 is arranged between the surface 13 and the objective lens 32, with the quarter-wave phase plate 33 perpendicular to the optical axis of the objective lens 32. The two photodiodes 34 and 35 are mounted on the same circuit board 36, both parallel to the surface 12 of the prism 5. One photodiode 34 faces the part of the surface 12 where the semitransparent film 22 is formed, and the other photodiode 35 faces the part of the surface 12 where the semitransparent film 22 is not formed.

The light emitted from the laser light source 31 strikes the polarizing beam splitting film 21 on the surface 13. Since the light here is linear-polarized and s-polarized with respect to the polarizing beam splitting film 21, it is all reflected therefrom. After being reflected from the polarizing beam splitting film 21, the light is transmitted through the quarter-wave phase plate 33, by which the light is converted into circular-polarized light. This light is then transmitted through the objective lens 32 so as to converge on the recording layer of the optical recording medium M, and is then reflected therefrom.

The light reflected by the optical recording medium M is transmitted through the objective lens 32, and is then transmitted through the quarter-wave phase plate 33, by which the light is converted back into linear-polarized light. Since the linear-polarized light here is p-polarized with respect to the polarizing beam splitting film 21, it is all transmitted through the polarizing beam splitting film 21 and then through the surface 13.

Here, when the light is transmitted, it is refracted, with the result that, after being transmitted, the light is inclined relative to the surface 12. This light strikes the part of the surface 12 where the semitransparent film 22 is formed. The light that strikes the surface 12 strikes the semitransparent film 22, so that one half of the light is transmitted therethrough and the other half is reflected therefrom. The light transmitted through the semitransparent film 22 reaches the photodiode 34. On the other hand, the light reflected from the semitransparent film 22 strikes the surface 11 so as to be reflected from the reflective film 23, then strikes the part of the surface 12 where the semitransparent film 22 is not formed so as to be transmitted therethrough, and then reaches the photodiode 35.

Of the surfaces 11 and 12 of the prisms 4 and 5, those parts through which they transmit light may have an anti-reflection film formed thereon. This helps increase light transmittance there.

The embodiments described above all deal with cases where polarizing beam splitting is performed on light in three wavelength bands centered around 405 nm, 650 nm, and 780 nm, respectively. It should be understood, however, that this is not meant to limit the application of the present invention to the wavelength bands specifically mentioned above; that is, the present invention can be applied to polarizing beam splitting films and polarizing beam splitting prisms designed for any other combination of three wavelength bands.

Obviously, many modifications and variations of the present invention are possible in light of the above teachings. It is therefore to be understood that within the scope of the appended claims, the invention may be practiced other than as specifically described.

1. A polarizing beam splitting film for transmitting p-polarized light and reflecting s-polarized light,
the polarizing beam splitting film comprising at least three types of thin film having different refractive indices,
wherein the polarizing beam splitting film performs polarizing beam splitting on light in three different wavelength bands.

2. A polarizing beam splitting film as claimed in claim 1,
wherein the polarizing beam splitting film performs polarizing beam splitting on light in wavelength bands of which center wavelengths are about 405 nm, about 650 nm, and about 780 nm, respectively.

3. A polarizing beam splitting film as claimed in claim 1,
wherein the polarizing beam splitting film is built with two types of thin film having refractive indices of 2.0 or more and one type of thin film having a refractive index of 1.5 or less.

4. A polarizing beam splitting film as claimed in claim 1,
wherein the polarizing beam splitting film is built with two types of thin film having refractive indices of 2.0 or more and two types of thin film having refractive indices of 1.65 or less.

5. A polarizing beam splitting film as claimed in claim 1,
wherein a material of a thin film having a highest refractive index is titanium dioxide.

6. A polarizing beam splitting film as claimed in claim 1,
wherein a material of a thin film having a lowest refractive index is silicon dioxide.

7. A polarizing beam splitting prism having a polarizing beam splitting film as claimed in claim 1 formed on a surface of a transparent substrate or at a bonding surface between transparent substrates.
